(19) United States
(12) Patent Application Publication
(10) Pub. No.: US 2015/0005937 A1
(43) Pub. Date: Jan. 1, 2015

(54) ACTION SELECTION APPARATUS AND METHODS

(71) Applicant: BRAIN CORPORATION, San Diego, CA (US)

(72) Inventor: Filip Ponulak, San Diego, CA (US)

(21) Appl. No.: 13/928,775

(22) Filed: Jun. 27, 2013

(51) Int. Cl. B25J 9/16; G06N 3/02

(52) U.S. Cl. CPC B25J 9/163; G06N 3/02; Y10S 901/47; Y10S 901/01
USPC 700/253; 700/250; 901/47; 901/1

(57) ABSTRACT

An action for execution by a robotic device may be selected. A robotic controller may determine that two or more actions are to be executed based on analysis of sensory and/or training input. The actions may comprise target approach and/or obstacle avoidance. Execution of individual actions may be based on a control signal and a separate activation signal being generated by the controller. Control signal execution may be inhibited by the controller relay block. Multiple activation signals may compete with one another in winner-take-all action selection network to produce selection signal. The selection signal may temporarily pause inhibition of a respective portion of the relay block that is associated with the winning activation signal channel. A disinhibited portion of the relay block may provide the respective control signal for execution by a controllable element. Arbitration between individual actions may be performed based on evaluation of activation signals.

### CROSS-REFERENCE TO RELATED APPLICATIONS

This application is related to co-pending and co-owned U.S. patent application Ser. No. 13/918,338 entitled “ROBOTIC TRAINING APPARATUS AND METHODS”, filed Jun. 14, 2013, U.S. patent application Ser. No. 13/918,298 entitled “HIERARCHICAL ROBOTIC CONTROLLER APPARATUS AND METHODS”, filed Jun. 14, 2013, U.S. patent application Ser. No. 13/918,620 entitled “PREDICTIVE ROBOTIC CONTROLLER APPARATUS AND METHODS”, filed Jun. 14, 2013, U.S. patent application Ser. No. 13/907,734 entitled “ADAPTIVE ROBOTIC INTERFACE APPARATUS AND METHODS”, filed May 31, 2013, U.S. patent application Ser. No. 13/842,530 entitled “ADAPTIVE PREDICTOR APPARATUS AND METHODS”, filed Mar. 15, 2013, U.S. patent application Ser. No. 13/842,562 entitled “ADAPTIVE PREDICTOR APPARATUS AND METHODS FOR ROBOTIC CONTROL”, filed Mar. 15, 2013, U.S. patent application Ser. No. 13/842,616 entitled “ROBOTIC APPARATUS AND METHODS FOR DEVELOPING A HIERARCHY OF MOTOR PRIMITIVES”, filed Mar. 15, 2013, U.S. patent application Ser. No. 13/842,647 entitled “MULTICHANNEL ROBOTIC CONTROLLER APPARATUS AND METHODS”, filed Mar. 15, 2013, U.S. patent application Ser. No. 13/842,583 entitled “APPARATUS AND METHODS FOR TRAINING OF ROBOTIC DEVICES”, filed Mar. 15, 2013, and U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013 each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates to adaptive control of robotic devices.

2. Background

Robotic devices are used in a variety of applications, such as manufacturing, medical, safety, military, exploration, and/or other applications. Some existing robotic devices (e.g., manufacturing assembly and/or packaging) may be programmed in order to perform desired functionality. Some robotic devices (e.g., surgical robots) may be remotely controlled by humans, while some robots (e.g., iRobot Roomba®) may learn to operate via exploration.

Robotic devices may comprise one or more actuators configured to enable the robot to perform various tasks. Two or more contemporaneously occurring tasks may attempt to utilize the same hardware resources (e.g., actuators). In some uses, different tasks may attempt to issue competing and/or discordant control instructions to actuators (e.g., an aiming controller may command a steady state platform motion while obstacle avoidance controller may command an evasive maneuver). Selecting (e.g., allowing) a given action from multiple competing and/or conflicting actions may be required. Action selection may be described as a task of resolving conflicts between competing behavioral alternatives. A robotic controller may be configured to perform a repertoire of actions. Based on knowledge of its internal state, and sensory information related to robot's environment, the robotic controller may be required to decide what action (or action sequence) to perform in order for that agent to accomplish a target task.

### SUMMARY

One aspect of the disclosure relates to a non-transitory computer readable medium having instructions embodied thereon. The instructions may be executable by a processor to perform a method for controlling a robotic platform. The method may comprise: providing a first activation signal, a second activation signal, a first motor control signal, and a second motor control signal, the first activation signal being associated with the first motor control signal and the second activation signal being associated with the second motor control signal; selecting the first motor control signal for execution, the selection based on a comparison of the first activation signal and the second activation signal; and instructing the robotic platform to perform a first action based on execution of the first motor control signal.

Another aspect of the disclosure relates to a robotic controller apparatus. The apparatus may comprise one or more processors configured to execute computer program modules. The computer program modules may be executable to cause one or more processors to: provide a first control signal and a second control signal, the first control signal being configured to operate first controllable element of a robotic platform and the second control signal being configured to operate a second controllable element of the robotic platform; provide a first activation signal and a second activation signal, the first control signal and the second control signal each being configured to enable actuation of the first and second controllable elements, respectively; determine an enable signal based on competitive information associated with the first control signal and the second control signal; and enable execution of one and only one of the first control signal or the second control signal based on the enable signal.

In some implementations, the first control signal and the second control signal may be provided based on sensory input into the controller apparatus. The sensory input may convey information associated with one or both of the robotic platform or the surroundings. The execution of the first control signal or the second control signal by the controllable element may be configured to enable the platform to accomplish a first task or a second task. Execution of the second task may be incompatible with execution of the first task.

In some implementations, the computer program may be executable to cause one or more processors to cause the first control signal to be provided to a first relay neuron and the second control signal to be provided to a second relay neuron. The first relay neuron may be configured to prevent execution by the controllable element of the first control signal absent the enable signal and the second relay neuron being configured to prevent execution by the controllable element of the second control signal absent the enable signal.

In some implementations, the prevention of the execution may be based on a first inhibitory signal and a second inhibitory signal being provided to the first relay neuron and the second relay neuron, respectively. The execution of the first control signal or the second control signal by the controllable element may be configured based on an interruption of one of the first or the second inhibitory signals. The interruption may be based on the enable signal.

In some implementations, the sensory input may comprise a video signal conveying a representation of one or both of a target or an obstacle. The first task may comprise a target approach maneuver. The second task may comprise an obstacle avoidance maneuver.

In some implementations, the first control signal and the first activation signals may be provided by a first task controller operable in accordance with the sensory input to execute the first task. The second control signal and the second activation signals may be provided by a second task controller operable in accordance with the sensory input to execute the second task. The interruption may be effectuated by activation of one of a first selection neuron or a second selection neuron. Activation of a given one of the first selection neuron or the second selection neuron may be effectuated based on the enable signal.

In some implementations, the activation of a given one of the first selection neuron or the second selection neuron may be effectuated based on the enable signal being configured based on evaluation of a parameter of the first activation signal versus the parameter of the second activation signal.

In some implementations, the evaluation may comprise comparing an onset of the first activation signal to the onset of the second activation signal. The parameter may comprise onset time.

In some implementations, the evaluation may comprise comparing a magnitude of the first activation signal to a magnitude of the second activation signal. The parameter may comprise activation signal magnitude.

In some implementations, the competitive information associated with the first control signal and the second control signal may include information based on an operation of a first selection neuron and a second selection neuron operable in accordance with a winner-take-all (WTA) process configured to produce the enable signal according to: configuring the enable signal to activate the first task based on the WTA process indicating the first activation signal as a winning signal; and configuring the enable signal to activate the second task based on the WTA process indicating the second activation signal as the winning signal.

Yet another aspect of the disclosure relates to a method of providing a selected control signal of a plurality of control signals to an actuator. The method may comprise: coupling individual ones of the plurality of control signals to a plurality of relays, individual ones of the plurality of relays being configured, responsive to being activated, to provide a respective control signal to the actuator; preventing provision of all but one of the plurality of control signals to the actuator by deactivating all but one of the of plurality of relays; based on a plurality of activation signals associated with individual ones of the plurality of control signals, determining a relay selection signal configured to activate a relay of the plurality of relays; and effectuating provision of the selected control signal responsive to activation of the relay of the plurality of relays based on the selection signal.

In some implementations, individual ones of the plurality of control signal may comprise a spiking signal.

In some implementations, the selected control signal and the selection signal may comprise spiking signals. Individual ones of the plurality of control signals may comprise at least one of a spiking signal or an analog signal.

In some implementations, individual ones of the plurality of activation signals may comprise a binary signal.

In some implementations, individual ones of the plurality of activation signals may comprise digital signal characterized by two or more bits.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram illustrating a robotic apparatus, according to one or more implementations.

FIG. 2 is a graphical illustration of a robot operation comprising action selection determination, according to one or more implementations.

FIG. 3 is a block diagram illustrating a controller apparatus comprising an adaptive action selection block, according to one or more implementations.

FIG. 4A is a plot depicting spiking activation signals associated with three task controllers for use with an adaptive action selection mechanism, according to one or more implementations.

FIG. 4B presents data illustrating spiking output of a selection block configured to implement a winner-take-all selection mechanism for use adaptive action selection mechanism, in accordance with one or more implementations.

FIG. 4C is a plot depicting spiking inhibitory signal corresponding to the selection signals of FIG. 4B for use adaptive action selection mechanism, in accordance with one or more implementations.

FIG. 5A presents data illustrating spiking control signal generated by the task controllers associated with the activation signal of FIG. 4A for use adaptive action selection mechanism, in accordance with one or more implementations.

FIG. 5B presents data illustrating activated spiking control output obtained using adaptive action selection mechanism, in accordance with one or more implementations.

FIG. 6 is a logical flow diagram illustrating a method of robotic device operation comprising execution of multiple tasks, in accordance with one or more implementations.

FIG. 7 is a logical flow diagram illustrating a method of using adaptive action selection methodology for task execution, in accordance with one or more implementations.

FIG. 8 is a logical flow diagram illustrating a method of relaying a control signal of a plurality of control signals to a controllable element of a robotic platform using tonic inhibition, in accordance with one or more implementations.

FIG. 9 is a graphical illustration depicting robotic apparatus operable using an adaptive action selection mechanism of the disclosure, in accordance with one or more implementations.

All Figures disclosed herein are © Copyright 2013 Brain Corporation. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation, but other implementations are possible by way of interchange of or combination with some or all of the described or illustrated elements. Wherever convenient, the same reference numbers will be used throughout the drawings to refer to same or like parts.

Where certain elements of these implementations can be partially or fully implemented using known components, only those portions of such known components that are necessary for an understanding of the present technology will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device” may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs), and/or other types of integrated circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.), IrDA families, and/or other network interfaces.

As used herein, the terms “node”, “neuron”, and “neuronal node” are meant to refer, without limitation, to a network unit (e.g., a spiking neuron and a set of synapses configured to provide input signals to the neuron) having parameters that are subject to adaptation in accordance with a model.

As used herein, the terms “state” and “node state” is meant generally to denote a full (or partial) set of dynamic variables (e.g., a membrane potential, firing threshold and/or other) used to describe state of a network node.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

As used herein, the term “Wi-Fi” includes one or more of IEEE-Std. 802.11, variants of IEEE-Std. 802.11, standards related to IEEE-Std. 802.11 (e.g., 802.11a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

In one aspect of the disclosure, apparatus and methods for robotic controller design directed at implementing an action selection mechanism. The robotic controller may comprise multiple task controllers configured to implement multiple control actions. Two or more actions may occur contemporaneous with one another. The approach disclosed herein may advantageously allow for coordination between individual task controllers based on the concept of priorities. Responsive to activation of two or more task controllers, an arbitrator block may be utilized in order to regulate (e.g., gate) execution of competing actions based on priorities associates with individual actions. In some implementations, a task with a higher priority may be executed ahead of a task with a lower priority.

In some implementations, task priority indication (e.g., priority status) may be configured separate from the control signal itself (e.g., motor control). Such implementation may make the process of action selection independent of the representation and/or strength of the control signal. By way of illustration: a weaker control signal accompanied by a higher priority indication may be executed in place (and/or ahead) of a stronger control signal, but having a lower priority.

The disclosure finds broad practical application. Implementations of the disclosure may be, for example, deployed in a hardware and/or software implementation of a computer-controlled system, provided in one or more of a prosthetic device, robotic device, and/or other apparatus. In some implementations, a control system may include a processor embodied in an application specific integrated circuit (ASIC), a central processing unit (CPU), a graphics processing unit (GPU), a digital signal processor (DSP) or an application specific processor (ASIP) or other general purpose multiprocessor, which can be adapted or configured for use in an embedded application such as controlling a robotic device. However, it will be appreciated that the disclosure is in no way limited to the applications and/or implementations described herein.

Principles of the present disclosure may be applicable to various control applications that use a spiking neural network as the controller and comprise a set of sensors and actuators that produce signals of different types. Examples of those applications may include one or more of a robot navigation controller, an automatic drone stabilization, robot arm control, and/or other applications. Some sensors may communicate their state data using analog variables, whereas other sensors employ spiking signal representation.

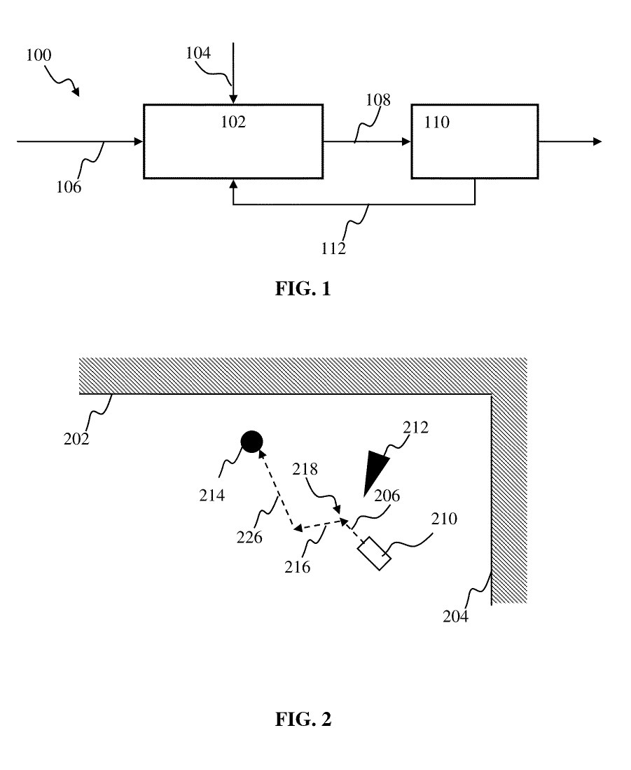

FIG. 1 illustrates one implementation of an adaptive robotic apparatus for use with the robot training methodology described hereinafter. The apparatus 100 of FIG. 1 may comprise an adaptive controller 102 and a robotic platform 110. The controller 102 may be configured to generate control output 108 for the robotic platform 110. The output 108 may comprise one or more motor commands (e.g., pan camera to the right), sensor acquisition parameters (e.g., use high resolution camera mode), commands to the wheels, arms, and/or other actuators on the robot, and/or other parameters. The output 108 may be configured by the controller 102 based on one or more sensory inputs 106. The input 106 may comprise data used for solving a particular control task. In one or more implementations, such as those involving a robotic arm or autonomous robot, the signal 106 may comprise a stream of raw sensor data and/or preprocessed data. Raw sensor data may include data conveying information associated with one or more of proximity, inertial, terrain imaging, and/or other information. Preprocessed data may include data conveying information associated with one or more of velocity, information extracted from accelerometers, distance to obstacle, positions, and/or other information. In some implementations, such as those involving object recognition, the signal 106 may comprise an array of pixel values in the input image, or preprocessed data. Pixel data may include data conveying information associated with one or more of RGB, CMYK, HSV, HSL, grayscale, and/or other information. Preprocessed data may include data conveying information associated with one or more of levels of activations of Gabor filters for face recognition, contours, and/or other information. In one or more implementations, the input signal 106 may comprise a target motion trajectory. The motion trajectory may be used to predict a future state of the robot on the basis of a current state and the target state. In one or more implementations, the signals in FIG. 1 may be encoded as spikes.

The controller 102 may be operable in accordance with a learning process (e.g., reinforcement learning and/or supervised learning). In one or more implementations, the controller 102 may optimize performance (e.g., performance of the system 100 of FIG. 1) by minimizing average value of a performance function as described in detail in co-owned U.S. patent application Ser. No. 13/487,533, entitled “STOCHASTIC SPIKING NETWORK LEARNING APPARATUS AND METHODS”, incorporated herein by reference in its entirety.

Learning process of adaptive controller (e.g., 102 of FIG. 1) may be implemented using a variety of methodologies. In some implementations, the controller 102 may comprise an artificial neuron network e.g., spiking neuron network described in U.S. patent application Ser. No. 13/487,533, entitled “STOCHASTIC SPIKING NETWORK LEARNING APPARATUS AND METHODS”, filed Jun. 4, 2012, incorporated supra, configured to control, for example, a robotic rover.

Individual spiking neurons may be characterized by internal state. The internal state may, for example, comprise a membrane voltage of the neuron, conductance of the membrane, and/or other parameters. The neuron process may be characterized by one or more learning parameter which may comprise input connection efficacy, output connection efficacy, training input connection efficacy, response generating (firing) threshold, resting potential of the neuron, and/or other parameters. In one or more implementations, some learning parameters may comprise probabilities of signal transmission between the units (e.g., neurons) of the network.

In some implementations, the training input (e.g., 104 in FIG. 1) may be differentiated from sensory inputs (e.g., inputs 106) as follows. During learning: data (e.g., spike events) arriving to neurons of the network via input 106 may cause changes in the neuron state (e.g., increase neuron membrane potential and/or other parameters). Changes in the neuron state may cause the neuron to generate a response (e.g., output a spike). Teaching data arriving to neurons of the network may cause (i) changes in the neuron dynamic model (e.g., modify parameters a,b,c,d of Izhikevich neuron model, described for example in co-owned U.S. patent application Ser. No. 13/623,842, entitled “SPIKING NEURON NETWORK ADAPTIVE CONTROL APPARATUS AND METHODS”, filed Sep. 20, 2012, incorporated herein by reference in its entirety); and/or (ii) modification of connection efficacy, based, for example, on timing of input spikes, teacher spikes, and/or output spikes. In some implementations, teaching data may trigger neuron output in order to facilitate learning. In some implementations, teaching signal may be communicated to other components of the control system.

During operation (e.g., subsequent to learning): data (e.g., spike events) arriving to neurons of the network may cause changes in the neuron state (e.g., increase neuron membrane potential and/or other parameters). Changes in the neuron state may cause the neuron to generate a response (e.g., output a spike). Teaching data may be absent during operation, while input data are required for the neuron to generate output.

In one or more implementations, such as object recognition, and/or obstacle avoidance, the input 106 may comprise a stream of pixel values associated with one or more digital images. In one or more implementations of e.g., video, radar, sonography, x-ray, magnetic resonance imaging, and/or other types of sensing, the input may comprise electromagnetic waves (e.g., visible light, IR, UV, and/or other types of electromagnetic waves) entering an imaging sensor array. In some implementations, the imaging sensor array may comprise one or more of RGCs, a charge coupled device (CCD), an active-pixel sensor (APS), and/or other sensors. The input signal may comprise a sequence of images and/or image frames. The sequence of images and/or image frame may be received from a CCD camera via a receiver apparatus and/or downloaded from a file. The image may comprise a two-dimensional matrix of RGB values refreshed at a 25 Hz frame rate. It will be appreciated by those skilled in the arts that the above image parameters are merely exemplary, and many other image representations (e.g., bitmap, CMYK, HSV, HSL, grayscale, and/or other representations) and/or frame rates are equally useful with the present invention. Pixels and/or groups of pixels associated with objects and/or features in the input frames may be encoded using, for example, latency encoding described in U.S. patent application Ser. No. 12/869,583, filed Aug. 26, 2010 and entitled “INVARIANT PULSE LATENCY CODING SYSTEMS AND METHODS”; U.S. Pat. No. 8,315,305, issued Nov. 20, 2012, entitled “SYSTEMS AND METHODS FOR INVARIANT PULSE LATENCY CODING”; U.S. patent application Ser. No. 13/152,084, filed Jun. 2, 2011, entitled “APPARATUS AND METHODS FOR PULSE-CODE INVARIANT OBJECT RECOGNITION”; and/or latency encoding comprising a temporal winner-take-all mechanism described U.S. patent application Ser. No. 13/757,607, filed Feb. 1, 2013 and entitled “TEMPORAL WINNER TAKES ALL SPIKING NEURON NETWORK SENSORY PROCESSING APPARATUS AND METHODS”, each of the foregoing being incorporated herein by reference in its entirety.

In one or more implementations, object recognition and/or classification may be implemented using spiking neuron classifier comprising conditionally independent subsets as described in co-owned U.S. patent application Ser. No. 13/756,372 filed Jan. 31, 2013, and entitled “SPIKING NEURON CLASSIFIER APPARATUS AND METHODS” and/or co-owned U.S. patent application Ser. No. 13/756,382 filed Jan. 31, 2013, and entitled “REDUCED LATENCY SPIKING NEURON CLASSIFIER APPARATUS AND METHODS”, each of the foregoing being incorporated herein by reference in its entirety.

In one or more implementations, encoding may comprise adaptive adjustment of neuron parameters, such neuron excitability described in U.S. patent application Ser. No. 13/623,820 entitled “APPARATUS AND METHODS FOR ENCODING OF SENSORY DATA USING ARTIFICIAL SPIKING NEURONS”, filed Sep. 20, 2012, the foregoing being incorporated herein by reference in its entirety.

In some implementations, analog inputs may be converted into spikes using, for example, kernel expansion techniques described in co pending U.S. patent application Ser. No. 13/623,842 filed Sep. 20, 2012, and entitled “SPIKING NEURON NETWORK ADAPTIVE CONTROL APPARATUS AND METHODS”, the foregoing being incorporated herein by reference in its entirety. In one or more implementations, analog and/or spiking inputs may be processed by mixed signal spiking neurons, such as U.S. patent application Ser. No. 13/313,826 entitled “APPARATUS AND METHODS FOR IMPLEMENTING LEARNING FOR ANALOG AND SPIKING SIGNALS IN ARTIFICIAL NEURAL NETWORKS”, filed Dec. 7, 2011, and/or co-pending U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013, each of the foregoing being incorporated herein by reference in its entirety.

The rules may be configured to implement synaptic plasticity in the network. In some implementations, the plastic rules may comprise one or more spike-timing dependent plasticity, such as rule comprising feedback described in co-owned and co-pending U.S. patent application Ser. No. 13/465,903 entitled “SENSORY INPUT PROCESSING APPARATUS IN A SPIKING NEURAL NETWORK”, filed May 7, 2012; rules configured to modify of feed forward plasticity due to activity of neighboring neurons, described in co-owned U.S. patent application Ser. No. 13/488,106, entitled “SPIKING NEURON NETWORK APPARATUS AND METHODS”, filed Jun. 4, 2012; conditional plasticity rules described in U.S. patent application Ser. No. 13/541,531, entitled “CONDITIONAL PLASTICITY SPIKING NEURON NETWORK APPARATUS AND METHODS”, filed Jul. 3, 2012; plasticity configured to stabilize neuron response rate as described in U.S. patent application Ser. No. 13/691,554, entitled “RATE STABILIZATION THROUGH PLASTICITY IN SPIKING NEURON NETWORK”, filed Nov. 30, 2012; activity-based plasticity rules described in co-owned U.S. patent application Ser. No. 13/660,967, entitled “APPARATUS AND METHODS FOR ACTIVITY-BASED PLASTICITY IN A SPIKING NEURON NETWORK”, filed Oct. 25, 2012, U.S. patent application Ser. No. 13/660,945, entitled “MODULATED PLASTICITY APPARATUS AND METHODS FOR SPIKING NEURON NETWORKS”, filed Oct. 25, 2012; and U.S. patent application Ser. No. 13/774,934, entitled “APPARATUS AND METHODS FOR RATE-MODULATED PLASTICITY IN A SPIKING NEURON NETWORK”, filed Feb. 22, 2013; multi-modal rules described in U.S. patent application Ser. No. 13/763,005, entitled “SPIKING NETWORK APPARATUS AND METHOD WITH BIMODAL SPIKE-TIMING DEPENDENT PLASTICITY”, filed Feb. 8, 2013, each of the foregoing being incorporated herein by reference in its entirety.

In one or more implementations, neuron operation may be configured based on one or more inhibitory connections providing input configured to delay and/or depress response generation by the neuron, as described in U.S. patent application Ser. No. 13/660,923, entitled “ADAPTIVE PLASTICITY APPARATUS AND METHODS FOR SPIKING NEURON NETWORK”, filed Oct. 25, 2012, the foregoing being incorporated herein by reference in its entirety

Connection efficacy updated may be effectuated using a variety of applicable methodologies such as, for example, event based updates described in detail in co-owned U.S. patent application Ser. No. 13/239, filed Sep. 21, 2011, entitled “APPARATUS AND METHODS FOR SYNAPTIC UPDATE IN A PULSE-CODED NETWORK”; 201220, U.S. patent application Ser. No. 13/588,774, entitled “APPARATUS AND METHODS FOR IMPLEMENTING EVENT-BASED UPDATES IN SPIKING NEURON NETWORK”, filed Aug. 17, 2012; and U.S. patent application Ser. No. 13/560,891 entitled “APPARATUS AND METHODS FOR EFFICIENT UPDATES IN SPIKING NEURON NETWORKS”, each of the foregoing being incorporated herein by reference in its entirety.

Neuron process may comprise one or more learning rules configured to adjust neuron state and/or generate neuron output in accordance with neuron inputs.

In some implementations, one or more leaning rules may comprise state dependent learning rules described, for example, in U.S. patent application Ser. No. 13/560,902, entitled “APPARATUS AND METHODS FOR STATE-DEPENDENT LEARNING IN SPIKING NEURON NETWORKS”, filed Jul. 27, 2012 and/or pending U.S. patent application Ser. No. 13/722,769 filed Dec. 20, 2012, and entitled “APPARATUS AND METHODS FOR STATE-DEPENDENT LEARNING IN SPIKING NEURON NETWORKS”, each of the foregoing being incorporated herein by reference in its entirety.

In one or more implementations, the one or more leaning rules may be configured to comprise one or more reinforcement learning, unsupervised learning, and/or supervised learning as described in co-owned and co-pending U.S. patent application Ser. No. 13/487,499 entitled “STOCHASTIC APPARATUS AND METHODS FOR IMPLEMENTING GENERALIZED LEARNING RULES, incorporated supra.

In one or more implementations, the one or more leaning rules may be configured in accordance with focused exploration rules such as described, for example, in U.S. patent application Ser. No. 13/489,280 entitled “APPARATUS AND METHODS FOR REINFORCEMENT LEARNING IN ARTIFICIAL NEURAL NETWORKS”, filed Jun. 5, 2012, the foregoing being incorporated herein by reference in its entirety.

Adaptive controller (e.g., the controller apparatus 102 of FIG. 1) may comprise an adaptable predictor block configured to, inter alia, predict control signal (e.g., 108) based on the sensory input (e.g., 106 in FIG. 1) and teaching input (e.g., 104 in FIG. 1).

FIG. 2 illustrates an exemplary trajectory of a robotic apparatus configured to learn target approach and obstacle avoidance. The apparatus 210 may comprise an autonomous rover in operable communication with a teaching agent. The rover 210 may be configured to approach and/or follow a target (e.g., a ball 214), while avoiding obstacles (e.g., 212) and/or the walls (e.g., 202, 204). In some implementations, the avoidance policy may comprise execution of turns, for example as described in detail in U.S. patent application Ser. No. 13/918,338 entitled “ROBOTIC TRAINING APPARATUS AND METHODS”, filed Jun. 14, 2013, incorporated supra.

Initially the rover 210 may proceed on a trajectory portion 206 towards the target 214. Robotic controller may execute a target approach (TA) task associated with the trajectory portion 206. Upon detecting a presence of an obstacle and/or a threat 212, the controller may adaptively alter task execution at a time corresponding to the location 218 in FIG. 2. An obstacle avoidance (OA) task may be given a higher priority. The rover may adaptively alter its path and navigate the trajectory portion 216. At a subsequent time instance, responsive to a diminished probability of a collision with the obstacle 212, the previously active OA controller may become less active (and/or altogether inactive). The TA task may be given control as there may be no obstacles to avoid. The rover may resume the approach, shown by the trajectory portion 226.

In some implementations, an exclusive control of a given controllable element an (e.g., an actuator) may be realized. A given controller with the highest priority may be activated (e.g., allowed to control the element) responsive to a priority determination. In some implementations, the actuator may comprise one or more of a motor for moving or controlling a mechanism or system; a component operated by a source of energy (e.g., electric current, hydraulic fluid pressure, pneumatic pressure and/or other source of energy), which converts that energy into motion; an electromechanical actuator; a fixed mechanical or electronic system; and/or other actuator. Such an actuator may be associated with specific software (e.g. a printer driver, robot control system, and/or other software). In some implementations, an actuator may be a human or other agent.

The teaching agent may provide teaching input to the rover 210 during training. The teaching agent may comprise a human trainer of the robot. The trainer may utilize a remote control apparatus in order to provide training input to the rover, e.g., during the trajectory alteration events 218 in FIG. 2. In one or more implementations, the remote control apparatus may comprise an adaptive controller configured based on rover's hardware and/or operational characteristics, e.g., as described in U.S. patent application Ser. No. 13/907,734 entitled “ADAPTIVE ROBOTIC INTERFACE APPARATUS AND METHODS”, filed May 31, 2013, incorporated supra. In some implementations, the remote control apparatus may comprise a clicker apparatus, and training may comprise determination of a cost-function, e.g., as described in U.S. patent application Ser. No. 13/841,980 entitled “ROBOTIC TRAINING APPARATUS AND METHODS”, filed Mar. 15, 2013, the forgoing being incorporated herein by reference in its entirety.

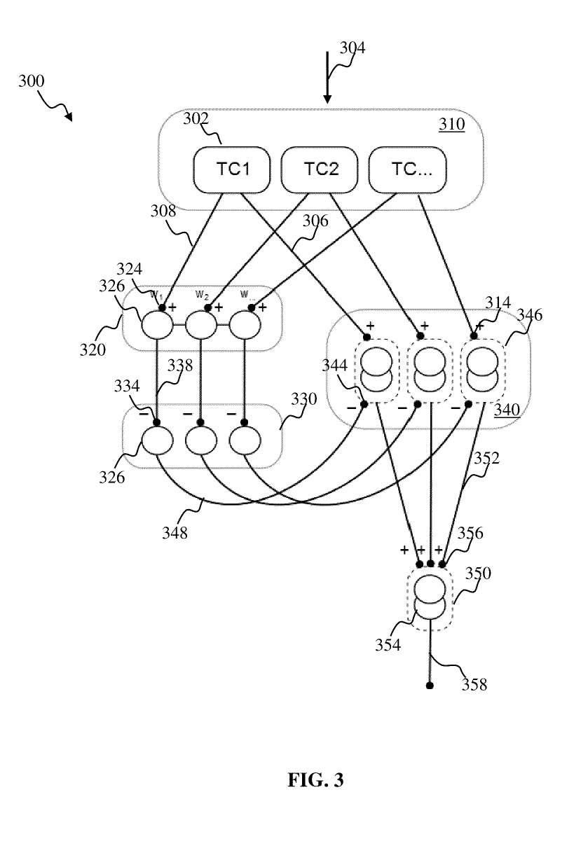

Operation of the robotic apparatus 210 of FIG. 2, may be based on an adaptive controller apparatus configured to implement adaptive action selection approach. FIG. 3 illustrates a controller apparatus comprising an adaptive action selection block, according to one or more implementations.

The controller 300 may comprise a task controller block 310. The task controller block 310 may comprise multiple task controllers. Individual task controllers (e.g., 302) may be configured to generate control output 306 based on input 304. The input 304 may comprise one or more of sensory input, estimated system state, input from a control entity, and/or other input. In some implementations, robotic platform feedback may comprise proprioceptive signals. Examples of proprioceptive signals may include one or more of readings from servo motors, joint position, torque, and/or other proprioceptive signals. In some implementations, the sensory input may correspond to the controller sensory input 106, described with respect to FIG. 1, supra. The control signal 306 may comprise one or more of motor commands (e.g., pan camera to the right, turn right wheel forward, and/or other motor commands), sensor acquisition parameters (e.g., use high resolution camera mode and/or other sensor acquisition parameters), and/or other parameters.

In one or more implementations, the control entity may comprise a human trainer. The human trainer may communicate with the robotic controller via user interface. Examples of such a user interface may include one or more of a remote controller, a joystick, and/or other user interface. In one or more implementations, the control entity may comprise a computerized agent. Such a computerized agent may include a multifunction adaptive controller operable using reinforcement, supervised, and/or unsupervised learning and capable of training other robotic devices for one and/or multiple tasks.

In one or more implementations, individual task controllers may comprise a predictor apparatus, for example such as an adaptive predictor described in U.S. patent application Ser. No. 13/842,530 entitled “ADAPTIVE PREDICTOR APPARATUS AND METHODS”, filed Mar. 15, 2013, incorporated supra.

The control signals (e.g., 306) of individual task controllers may be provided to relay block 340. The relay block 340 may comprise one or more neurons 346. Connections coupling the signal 306 from the task control block 310 to the relay block 340 may be characterized by connection efficacy 344. In some implementations, the efficacy 344 may comprise a positive value causing excitatory input to the neurons of the relay block 340. Connection efficacy may in general refer to a magnitude and/or probability of input spike influence on neuronal response (i.e., output spike generation or firing). Connection efficacy may comprise, for example, a synaptic weight parameter by which one or more state variables of post synaptic unit are changed. During operation of the pulse-code network, synaptic weights may be dynamically adjusted using various forms of machine learning or biologically-inspired learning methods, for example, by what is referred to as the spike-timing dependent plasticity (STDP). In one or more implementations, STDP mechanism may comprise rate-modulated plasticity mechanism described, for example, in U.S. patent application Ser. No. 13/774,934, entitled “APPARATUS AND METHODS FOR RATE-MODULATED PLASTICITY IN A SPIKING NEURON NETWORK”, and/or bi-modal plasticity mechanism, for example, such as described in U.S. patent application Ser. No. 13/763,005, entitled “SPIKING NETWORK APPARATUS AND METHOD WITH BIMODAL SPIKE-TIMING DEPENDENT PLASTICITY”, each of the foregoing being incorporated herein by reference in its entirety. In some implementations, learning may be goal-oriented and realized for example by the use of reward-modulated STDP, e.g., as described in U.S. patent application Ser. No. 13/554,980, entitled “APPARATUS AND METHODS FOR REINFORCEMENT LEARNING IN LARGE POPULATIONS OF ARTIFICIAL SPIKING NEURONS”, filed on Jul. 20, 2012, the foregoing being incorporated herein by reference in its entirety.

The task controller 302 may be configured to provide an activation signal 308 associated with the control signal 306. In one or more implementations, the activation signal may comprise a spiking signal, a fixed point/floating point value stored in a register, a binary signal, and/or another representation. In one or more implementations, the activation signal may take binary values. For example, such binary values may include a ‘1’ corresponding to the active state of the controller and a ‘0’ corresponding to the inactive controller state. The controller may be configured to provide the activation signal ‘1’ based on a detection of a relevant context. In some implementations, the relevant context may correspond to a detection of an object representation (e.g., green ball) in the video input. For example, for the OA controller, the appropriate context may correspond to the sensory input signals indicating nearby obstacles in front of the robot. In this case, the OA may send the activation signal ‘1’ and otherwise ‘0’ may be sent.

In some implementations, the activation signal 308 may comprise a continuous real value, e.g., as described in detail in U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013, incorporated supra.

The activation signal 308 may be provided to a selector block 320. In some implementations, the selector block 320 may comprise a winner-take-all network comprising one or more neurons 326. The neurons 326 may be configured to adjust efficacy 324 of connections delivering the activation signals 308 from the block 310 in order to determine which of the control actions from the task controllers should be executed at a given time. In one or more implementations, the activation signals may be characterized by two states: the low state (task controller inactive) and the high state (the task controller active). High state activation signals which may compete with one another within the selector block. The winner may be determined by the priorities, which may be encoded by the block 320. In some implementations, the task priority may be encoded using the efficacy 324. In one or more implementations the efficacy (and thus the priorities) may be adjusted such as to optimize the overall behavior of the system towards accomplishing a given task. The task accomplishment may be based on a control policy (e.g., lowest energy use, fastest time, lowers mean deviation from a target trajectory, and/or other policies). For example, in a task where a mobile robot may be configured to collect a set of certain objects (target objects) and navigate in a given environment such not to run into other objects (obstacles), the control policy (or a cost function) may be configured to minimize time necessary to collect the target objects without hitting any obstacles. Various optimization methods, for example reinforcement learning, may be used to in order to adjust efficacies from the TA and OA controllers such to meet the control policy for the given task.

In some implementations, activation of selection block neurons (e.g., the neuron 326 in FIG. 3) may be based on magnitude of the activation signal 308. In one or more implementations, magnitude of the activation aᵢ signal 308 may be weighted based efficacy 324 wᵢ as follows:

Aᵢ=wᵢaᵢ (Eqn. 1)

Task selection may be implemented by selecting the largest weighted activation signal Aᵢ, e.g., as:

max(Aᵢ),i:{1, . . . N} (Eqn. 2)

when more than one activation signals aᵢ is present at a given time. In some implementations, individual activation signals (e.g., 324) of two or more task controllers may be configured at a given fixed magnitude (e.g., binary ‘0’ or ‘1’). In some implementations, the activation signal may be configured with varying magnitude. By way of illustration, when implementing a target approach with a control policy configured based on target size and/or weight, the control signal for a given target may be configured based on target size. For an obstacle avoidance control policy configured based on obstacle value and/or facility, the control signal for a given obstacle may be configured based on obstacle value and/or fragility. Information about targets and/or obstacles (e.g., size, weight, fragility, value, and/or other parameters) may be acquired by the robotic device in real time, based, for example, on sensory input, teaching signal, and/or other information. In some implementations, such data may be provided a priori and/or received via a remote link responsive to, for example, a request from a robot (e.g., “Is this a valuable target?”).

In some implementations, efficacy 324 may comprise weights configured in accordance with a control policy of the control task. By way of illustration, in some implementations of a vacuum cleaning robot (e.g., operating target approach and/or obstacle avoidance tasks) the obstacle avoidance task may be given a greater weight in order to reduce probability of a collision (e.g., for a robot operating in a museum, a stock room, and/or another application wherein a collision may cause damage to the robot and/or environment). In some implementations, e.g., when cleaning a toy room, cleaning may be designated as a greater priority while tolerating a given amount of collisions.

The selection block 320 may be coupled to inhibitor block 330 via one or more connections 338 characterized by inhibitory efficacy 334. The inhibitor block 330 may comprise one or more neurons 336 operated in accordance with a tonically active process. The tonically active process of a given neuron 336 may be characterized by generation of an output comprising plurality of spikes. In some implementations, tonic output may be characterized by a number of spikes within a given time duration (e.g., average spike rate), and/or inter-spike interval. The output of neurons 336 may be delivered to the relay block 340 via connections 348. The connections 348 may be characterized by inhibitory efficacy 344 configured to inhibit and/or suppress output generation by neurons 346 of the relay block 340.

In one or more implementations, inhibition of neurons 326 may be effectuated by deactivating their output (e.g., via output of the inhibited neurons for a period of time and/or by temporary disconnecting excitatory inputs to the inhibited neurons). In some implementations, inhibition may be realized by affecting the state of the inhibited neuron models, such to decrease the probability of their firing.

Based on inhibitory efficacy 334 breaching a threshold, one or more neurons of neurons 336 may become inhibited. An inhibited neuron 336 may reduce and/or altogether stop generation of tonic output on the connection 348. Responsive to absence of tonic output on connection 348, neurons 346 of the relay layer may become disinhibited (e.g., active). Active neurons 346 may propagate input control signals 306 from the respective (e.g., the winning) controller 302 to the output 352 of the relay block 340. The aggregation block 350 may be used to combine outputs of the relay block thereby generating the controller output 350. In some implementations, the aggregation block may comprise an aggregation neuron 356 configured such as to ensure that for command signals of a winning controller may be further relayed to a common and/or individually assigned destination modules. In some implementations, the destination modules may comprise robot actuators and/or motor controllers (e.g. PID controllers). It will be appreciated by those skilled in the arts that the controller configuration shown in FIG. 3 is exemplary and other configurations may be utilized. For example, in some implementations, the aggregation block 350 may be incorporated into the relay block 340.

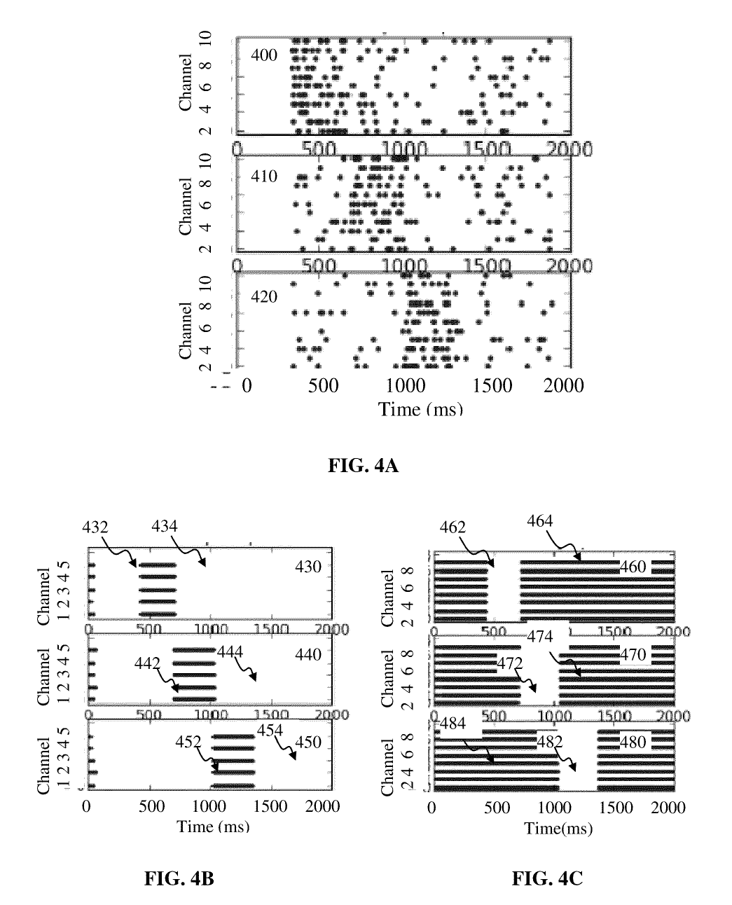

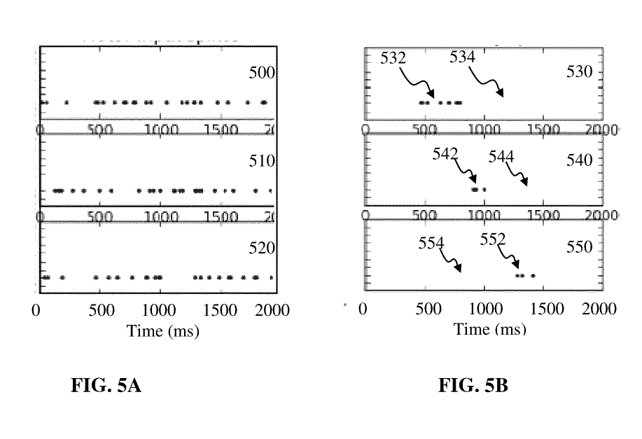

FIGS. 4A-5B present exemplary performance results obtained during simulation and testing, performed by the Assignee hereof, of an exemplary computerized spiking network apparatus configured to implement the adaptive action selection framework described herein.

In the exemplary network associated with FIGS. 4A-5B, three task controllers may be configured to execute tasks T1 (‘approach green target objects’), T2 (‘approach red target objects’), T3 (‘avoid obstacles’), respectively. Individual task controller's may generate corresponding spiking control signals (e.g., motor actuator commands) and spiking action selection signals. Individual task controllers may be configured such that the task controller T3 has the highest priority, the controller T2 has the second highest priority, and T1 has the lowest priority. The priorities may be determined by the efficacies of synaptic connections from the controllers to the selection block (i.e., w(T1)<w(T2)<w(T3)). Object and/or obstacle detection may be configured based on sensory input, e.g., video camera stream. An individual task controller may be configured to comprise 10 output channels for the activation signals. In this particular example, the activation signals produced by the individual controllers are encoded by the level of the mean spike-rate on all 10 channels collectively.

In the exemplary network associated with FIGS. 4A-5B, activation of a particular controller may be determined based on sensory inputs to the particular controllers. For example, responsive to a controller T1 (or T2) detecting green (or red) target objects in the given workspace of interest, the activation level of the controller may be increased. Such an activation level increase may be manifested by an increased firing-rate on the activation outputs from the controller. Responsive to the controller detecting one or more obstacles in the workspace, activation level associated with T3 may be increased. In some implementations, mean-firing rate of the activation signal corresponding to T3 may be increased. Specifically in the example presented in FIG. 4A, the controller T1 may be active in the time period between 400 ms and 750 ms, the controller T2 may be active in the time period between 650 ms and 1050 ms, and controller T3 may be active in the time period between 950 ms and 1300 ms.

In the exemplary network associated with FIGS. 4A-5B, the activation signals may be passed to the selection block through the excitatory inputs. In some implementations, such as those associated with FIGS. 4A-5B, the selection block may be implemented as a winner-take-all network comprising three populations of neurons (selector modules). Individual populations of neurons may comprise five spiking neurons of the leaky-integrate-and-fire (LIF) type. The particular selector modules may be connected to each other (all-to-all) through inhibitory connections. The selector module receiving the strongest activation signal may exhibits the highest activity. The selector module exhibiting the highest activity may suppress other selector modules via inhibitory lateral connections. The suppressed selector modules may remain inactive regardless of whether they receive excitatory inputs. The active selector module may be referred to as the winner. In some implementations, the winning module may be characterized by higher mean-firing rate of its neurons, compared to neurons of the suppressed selector modules. In some implementations, such as those associated with FIGS. 4A-5B, the selector module receiving inputs from T1 may correspond to the winner throughout the period of time between 400 ms and 650 ms, the selector module receiving inputs from T2 may correspond to the winner between 650 ms and 950 ms, and the selector module receiving inputs from T3 may correspond to the winner between 950 ms and 1300 ms. At other times, no task controller may remain active (i.e., all controllers send low-firing-rate activation signals) and so there is no specified winner selector module at that times. The high-state activation periods of the task controllers may overlap, in one or more implementations. In the example shown in FIGS. 4B-4C, the controllers T1 and T2 may be both active between 650 ms and 750 ms. In this period, the selector module corresponding to T2 is the winner, because it received a stronger activation signal (due to higher priority) than the one selector module corresponding to T1.

In the exemplary network associated with FIGS. 4A-5B, the inhibition block may comprise three groups of tonically active neurons (inhibition modules) configured to produce inhibition signals. Individual inhibition modules may receive inhibitory inputs from the corresponding selector modules (one selector module projecting on one inhibition module). Individual inhibition modules may comprise eight spiking neurons of the LIF type. The tonic spiking output of the inhibition module neurons may be characterized by an average spike rate of 400 Hz. Responsive to receipt of inhibition from the corresponding selector modules by the tonically active neurons in the inhibitory modules, the activity of tonically active neurons in the inhibitory modules may be suppressed to 0 Hz (462, 472 and 482 in FIG. 4C).

In the exemplary network associated with FIGS. 4A-5B, a relay block may comprise three relay modules. Individual relay module may comprise a spiking relay neuron configured to relay spiking motor control input based on a gating signal from the respective inhibitory block. An individual really neuron may receive a motor command from the corresponding task controller. The motor commands may be encoded as temporal sequences of spikes (FIG. 5A). In some implementations, a controller may send motor commands responsive to a task characterized by absence of activity. By way of illustration, a controller may send one or more commands directing a robot to maintain its present state. Due to the tonic inhibition of the relay modules by the inhibitory modules, such control commands may not be delivered to the target controllable element (e.g., actuator). Once one or more of the task controllers become active, they may activate the corresponding selection module and the winning selection module may inhibit the corresponding inhibitory modules. The inhibition of the inhibitory modules may result in the disinhibition of the corresponding relay module thus allowing for the motor commands from the winning controller to be further relayed.

In the exemplary network associated with FIGS. 4A-5B, an aggregation block comprising a single spiking neuron was configured to route one of the three input control signals to a control element (e.g., an actuator).

FIG. 4A presents data illustrating activation signal activity of three task controllers. As can be seen from the data in FIG. 4A, the activation signal of the first task controller (panel 400) may be characterized by an increased activity level between about 400 ms and 750 ms, the activation signal of the second task controller (panel 410) may be characterized by an increased activity level between about 650 ms and 1050 ms, and the activation signal of the third task controller (panel 420) may be characterized by an increased activity level between about 950 ms and 1300 ms.

FIG. 4B presents data illustrating output activity of the selector block (e.g., 320 of FIG. 3). As can be seen from the data in FIG. 4B, output activity of the first selector sub-block (panel 430) may be characterized by tonic activity 432 between about 400 ms and 750 ms, neurons of the first selector sub-block may remain inactive outside the interval 432 as illustrated by absence of spikes during an interval denoted by arrow 434, output activity of the second selector sub-block (panel 440) may be characterized by tonic activity 442 by all neurons between about 650 and 1050 ms, the second selector sub-block (panel 430) neurons may remain inactive outside the interval of activity 442 as illustrated by absence of spikes during an interval denoted by arrow 444, output activity of the third selector sub-block (panel 450) may be characterized by tonic activity 452 by all neurons between about 950 ms and 1300 ms, and the second selector sub-block (panel 430) neurons may remain inactive outside the interval of activity 452 as illustrated by absence of spikes during an interval denoted by arrow 454 in FIG. 4B.

FIG. 4C presents data illustrating activation signal activity of the inhibitory block (e.g., 330 of FIG. 3). As can be seen form the data in FIG. 4C, output activity of the first inhibition sub-block (panel 460) may be characterized by absence of tonic activity (denoted by arrow 462 and referred to as a pause) between about 400 and 750 ms, neurons of the first inhibition sub-block may remain tonically active outside the interval 462 as illustrated by spikes during an interval denoted by arrow 464, output activity of the second inhibition sub-block (panel 470) may be characterized by absence of tonic activity (denoted by arrow 472 and referred to as a pause) between about 650 ms and 1050 ms, neurons of the second inhibition sub-block may remain tonically active outside the interval 472 as illustrated by spikes during an interval denoted by arrow 474, output activity of the third inhibition sub-block (panel 460) may be characterized by absence of tonic activity (denoted by arrow 482 and referred to as a pause) between about 950 and 1300 ms, and neurons of the third inhibition sub-block may remain tonically active outside the interval 482 as illustrated by spikes during an interval denoted by arrow 484.

FIG. 5A presents data illustrating control signal activity of the task controller block (e.g., the controller block 310 in FIG. 3). Output activity of individual task controllers (e.g., corresponding to the activation signals shown by panels 400, 410, 420 in FIG. 4A) is presented in panels 500, 510, 520, respectively, in FIG. 5A.

FIG. 5B presents data illustrating control signals gated by the relay block (e.g., the block 340 in FIG. 3). As can be seen form the data in FIG. 5B, output activity of the first relay sub-block (panel 530) may be characterized by spiking activity 532 between about 400 ms and 750 ms that corresponds to the selection signal timing shown in panel 432 of FIG. 4B, output activity of the second relay sub-block (panel 540) may be characterized by spiking activity 542 between about 650 ms and 950 ms that corresponds to the selection signal timing shown in panel 442 of FIG. 4B, and output activity of the third relay sub-block (panel 550) may be characterized by spiking activity 552 between about 950 ms and 1300 ms that corresponds to the selection signal timing shown in panel 452 of FIG. 4B.

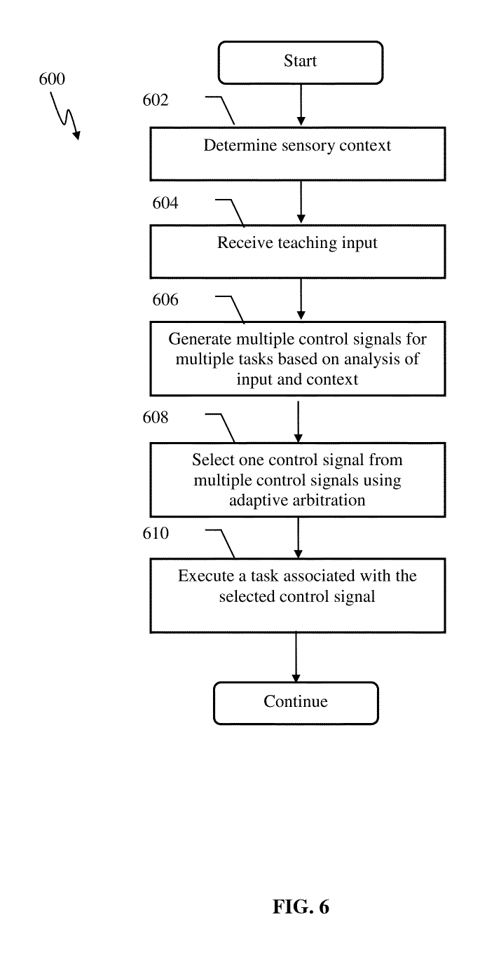

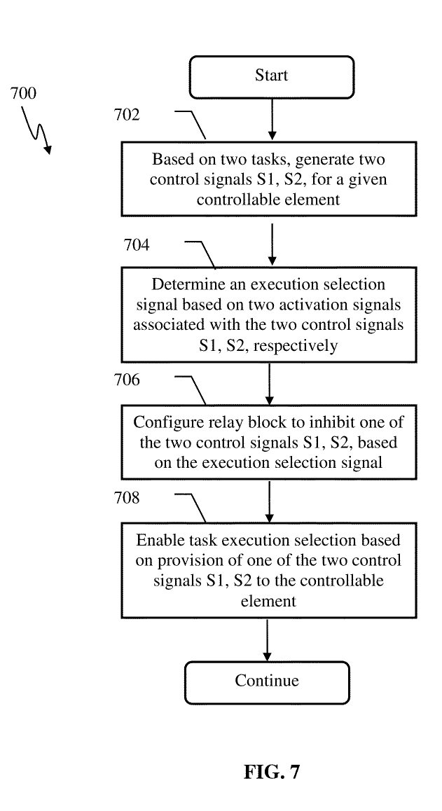

FIGS. 6-8 illustrate methods of training an adaptive apparatus of the disclosure in accordance with one or more implementations. The operations of methods 600, 700, 800 presented below are intended to be illustrative. In some implementations, methods 600, 700, 800 may be accomplished with one or more additional operations not described, and/or without one or more of the operations discussed. Additionally, the order in which the operations of methods 600, 700, 800 are illustrated in FIGS. 6-8 described below is not intended to be limiting.

In some implementations, methods 600, 700, 800 may be implemented in one or more processing devices (e.g., a digital processor, an analog processor, a digital circuit designed to process information, an analog circuit designed to process information, a state machine, and/or other mechanisms for electronically processing information and/or execute computer program modules). The one or more processing devices may include one or more devices executing some or all of the operations of methods 600, 700, 800 in response to instructions stored electronically on an electronic storage medium. The one or more processing devices may include one or more devices configured through hardware, firmware, and/or software to be specifically designed for execution of one or more of the operations of methods 600, 700, 800.

Referring now to FIG. 6, a method of robotic device operation comprising execution of multiple tasks is disclosed, in accordance with one or more implementations.

At operation 602 of method 600, sensory context may be determined. In some implementations, the context may comprise one or more aspects of sensory input (e.g., 106) and/or robotic platform feedback (112 in FIG. 1). In one or more implementations, the sensory aspects may include an object being detected in the input, a location of the object, an object characteristic (color/shape), a sequence of movements (e.g., a turn), a characteristic of an environment (e.g., an apparent motion of a wall and/or other surroundings, turning a turn, approach, and/or other environmental characteristics responsive to the movement. In some implementations, the sensory input may be received based on performing one or more training trials of a robotic apparatus.

At operation 604, a teaching input may be received. In some implementations, the teaching input may comprise a control command (e.g., rotate right/left wheel and/or other command) configured based on the sensory context (e.g., appearance of a target in field of view of the robot's camera, and/or other sensory context) and provided by a human user. In one or more implementations, the teaching input signal may comprise a portion of sensory input, e.g., a signal from a touch sensor indicating an obstacle.

At operation 606, the teaching input and the context may be analyzed. In one or more implementations, the analyses of operation 606 may comprise generation of one or more control signals (e.g., 306 of FIG. 3) configured to execute two or more tasks (e.g., target approach/obstacle avoidance). Two or more of the control signals generated at operation 606 may be configured to activate the same controllable element (e.g., a wheel motor). In some implementations, two of the control signals may convey instructions that are incompatible with one another (e.g., opposing). For example, one control signal may convey instructions to ‘turn right’ while the other control signal may convey instructions to ‘turn left’; one control signal may convey instructions to open manipulator while the other control signal may convey instructions to close the manipulator; one control signal may convey instructions to turn a switch on while the other control signal may convey instructions to turn the switch off, one control signal may convey instructions to increase a control parameter (e.g., seed, torque, angle, and/or other) while the other control signal may convey instructions to decrease control parameter.

At operation 608 of method 600, a control signal may be selected from multiple control signals. In some implementations, the control signal selection may be based on evaluation of multiple activation signals using adaptive arbitration methodology described, for example, with respect to FIGS. 3-5B above and/or FIG. 7 below.

At operation 610, a task associated with the control signal selected at operation 608 may be executed. In one or more implementations, an obstacle 212 avoidance task may be executed, as described for example, with respect to FIG. 2 above.

FIG. 7 illustrates a method of using the adaptive action selection methodology for task execution, in accordance with one or more implementations.

At operation 702, based on an identification of two tasks to be executed, two control signals S1, S2 may be generated. The individual tasks S1, S2, may be configured to operate a given controllable element (e.g., a wheel or an arm motor). The control signals may be provided to a relay block (e.g., 340 in FIG. 3).

At operation 704, an execution selection signal may be determined based on two activation signals associated with the two control signals S1, S2, respectively. In one or more implementations, the execution selection signal may comprise a signal transmitted via connection 338 as described above with respect to FIG. 3.

At operation 706, a relay block may be configured to impede delivery of first of the two control signals S1, S2 to the controllable element.

At operation 708, the relay block may be configured to provide the second of the two control signals to the controllable element. The provision of the second of the control signals S1, S2 to the controllable element may be based on activation of the relay block by the execution selection signal obtained at operation 706.

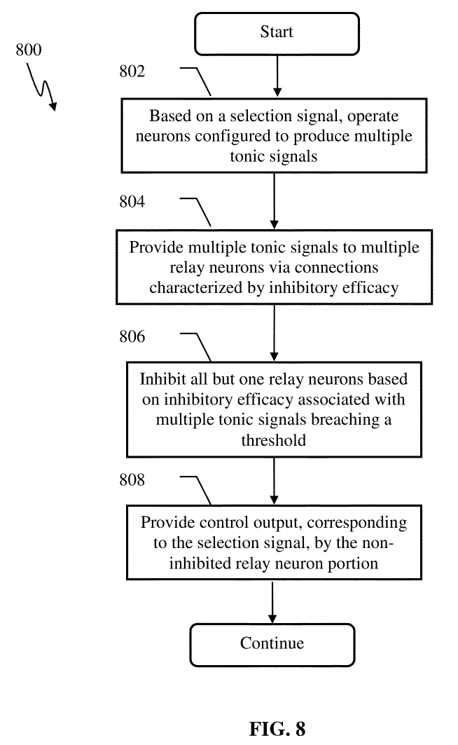

FIG. 8 illustrates a method of relaying a control signal of a plurality of control signals to a controllable element of a robotic platform using tonic inhibition, in accordance with one or more implementations. In one or more implementations, the method 800 of FIG. 8 may be effectuated by a spiking neuron network configured to implement adaptive action selection controller, e.g., as described above with respect to FIG. 3.

At operation 802, a portion of the network may be configured to produce multiple tonic signals. In one or more implementations, individual tonic signals may correspond to spiking signals shown in FIG. 4C. At least one of the multiple tonic signals may be characterized by absence of tonic activity during time interval configured based on a selection signal (e.g., time interval 462 in FIG. 4C).

At operation 804, the multiple tonic signals may be provided to respective relay neurons via connections characterized by inhibitory efficacy, e.g., connections 348 in FIG. 3.

At operation 806, all but one relay neurons may be inhibited based on the inhibitory efficacy associated with multiple tonic signals breaching a threshold.

At operation 808, control output, corresponding to the selection signal, may be provided to a controllable element by the non-inhibited relay neuron(s).

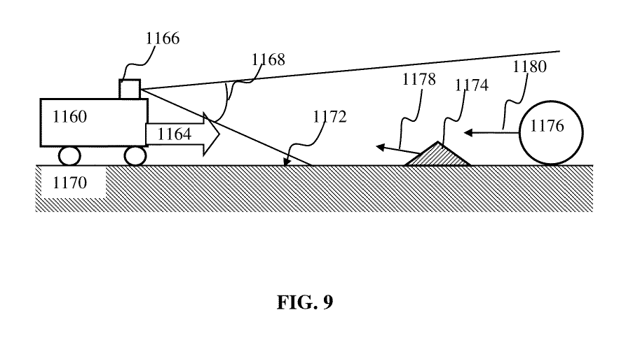

FIG. 9 illustrates a mobile robotic apparatus that may comprise an adaptive controller configured to implement action selection mechanism described herein. The robotic apparatus 1160 may comprise a camera 1166. The camera 1166 may be characterized by a field of view 1168. The camera 1166 may provide information associated with objects within the field of view. In some implementations, the camera 1166 may provide frames of pixels conveying luminance, refreshed at 25 Hz frame rate.

One or more objects (e.g., an obstacle 1174, a target 1176, and/or other objects) may be present in the camera field of view. The motion of the objects may result in a displacement of pixels representing the objects within successive frames, such as described in U.S. patent application Ser. No. 13/689,717, entitled “APPARATUS AND METHODS FOR OBJECT DETECTION VIA OPTICAL FLOW CANCELLATION”, filed Nov. 30, 2012, incorporated, supra.

When the robotic apparatus 1160 is in motion, such as indicated by arrow 1164 in FIG. 9, the optical flow estimated from the image data may comprise the self-motion component and the object motion component. By way of a non-limiting example, the optical flow measured by the rover of FIG. 9 may comprise one or more of (i) self-motion components of the stationary object 1178 and the boundary (e.g., the component 1172 associated with the floor boundary); (ii) component 1180 associated with the moving objects 1176 that comprises a superposition of the optical flow components due to the object displacement and displacement of the robotic apparatus, and/or other components. In one or more implementation, the robotic apparatus 1160 may be trained to avoid obstacles (e.g., 1174) and/or approach targets (e.g., 1176) using adaptive action selection methodology, e.g., as described with respect to FIGS. 2-8, supra.

Various exemplary computerized robotic apparatus may be utilized with the action selection methodology of the disclosure. In some implementations, the robotic apparatus may comprise one or more processors configured to execute the adaptation methodology described herein. In some implementations, an external processing entity (e.g., a cloud service, computer station and/or cluster, and/or other processing entity) may be utilized in order to perform computations during operation of the robot (e.g., operations of methods 600, 700, 800).

Action selection methodology described herein may enable autonomous operation of robotic controllers. In some implementations, training of the robot may be based on a collaborative training approach wherein the robot and the user collaborate on performing a task, e.g., as described in owned U.S. patent application Ser. No. 13/918,338 entitled “ROBOTIC TRAINING APPARATUS AND METHODS”, filed Jun. 14, 2013. In one or more implementations, operation of robotic devices may be aided by an adaptive controller apparatus, e.g., as described in U.S. patent application Ser. No. 13/918,298 entitled “HIERARCHICAL ROBOTIC CONTROLLER APPARATUS AND METHODS”, filed Jun. 14, 2013, U.S. patent application Ser. No. 13/918,620 entitled “PREDICTIVE ROBOTIC CONTROLLER APPARATUS AND METHODS”, filed Jun. 14, 2013, and/or U.S. patent application Ser. No. 13/907,734 entitled “ADAPTIVE ROBOTIC INTERFACE APPARATUS AND METHODS”, filed May 31, 2013, incorporated supra. In some implementations, the adaptive controller may comprise one or more adaptive predictor controllers such as, for example, these described in U.S. patent application Ser. No. 13/842,530 entitled “ADAPTIVE PREDICTOR APPARATUS AND METHODS”, filed Mar. 15, 2013, incorporated supra.

Separating priority (or activation) signals from the control signals may enable action selection for a broader variety of control signals including for example, control signals based on binary, real-valued, message-based communication, use of pauses, and/or other communication methods.

Action selection methodology described herein may provide additional flexibility for selecting one or more actions by a robotic system performing a complex task. In some implementations, such complex task may comprise a composite task (e.g., serve a beverage by a mobile robot). Such target task (serving the coffee) may be decomposed into multiple sub-tasks, including, for example, one or more of identifying a beverage container, grasping the container, placing it under a dispenser, dispensing the beverage, carrying the container to a target destination, navigating obstacles during the traverse, placing the beverage at a target location, and/or other actions. Such decomposition may provide a mechanism allowing a developer of a robotic controller to decompose the problem of building intelligent systems into relatively simple components or modules and then reintegrate or coordinate the overall behavior.

In some implementations, the action selection methodology described herein may be employed for control of intelligent robotic devices configured to select one or more behaviors from a repertoire of behaviors (e.g. target approach versus obstacle avoidance versus exploration). These robotic devices may comprise mobile robots, robotic arms, and/or other robotic devices. In some implementations, the adaptive action selection controller may be configured to control a multi-agent system for coordinating behavior of the particular agents in the system. By way of illustration, the multi-agent system may comprise a plurality of autonomous mobile robots configured to operate in collaboration with one another in order to accomplish a task. In one or more implementations, the task may comprise exploring a certain environment for surveillance, cleaning, inspection, and/or other applications. Some applications may include disaster response, agriculture, factory maintenance, border security, and/or other applications.

Individual robots may be configured to prioritize and/or coordinate their actions with other robots. For example, an exploration domain of first robot may configure to not overlap with the exploration domain of a second robot. The second robot may configure its exploration route to avoid the first domain based on the exploration of the first domain by the first robot. In some implementations, individual robots may communicate to one another location of obstacles, hazards, charging stations, and/or other information about the environment.

Actions executed by individual robots that may be related to achievement of the overall task (e.g., cleaning refuse in a building) may be referred to as ‘global actions’ and denoted as TG1, TG2, . . . TGN. Examples of the global actions TG1, TG2, . . . , TGN may include. “explore room A”, “collect an object from room B”, and/or other actions. One or more actions may be communicated to individual robot by a system coordinator based on information provided by one or more robots. In some implementations, the system coordinator may comprise one of the robots, a human operator, a centralized and/or a distributed computerized controller.

Actions executed by individual robots that may be related to fulfillment of a given global action by the robot may be referred to as local actions and denoted as TL1, TL2, . . . , TLM. Examples of local actions TL1, TL2, . . . , TLM may include operations related to safety of the robot, its energy resource status, and/or other parameters. The robot may be configured to execute operations TL1, TL2, . . . , TLM autonomously.

In some implementations, the adaptive action selection methodology described herein may be employed in order to arbitrate behavior of the individual robot by adaptively coordinating action selection over an action set consisting of {{TG1, TG2, . . . , TGN}, {TL1, TL2, . . . , TLM}}.

An exemplary list of action to be arbitrated may include:
execute action TG1=“go to room A”;
execute action TL1=“when idle, randomly explore the environment”; and
execute action TL2=“avoid any obstacle that may be encountered”.
   An arbitration operation for the above actions may be configured by setting action priorities as follows:
priority(TL2) is greater than priority(TG1) which is greater than priority(TL1).

The action arbitrator may be implemented using a spiking neural network as described herein. In one or more implementations, the adaptive controller capability to generate control signal prior to or in lieu of the teaching input may enable autonomous operation of the robot and/or obviate provision of the teaching input. In some applications, wherein a teacher may be configured to control and/or train multiple entities (e.g., multiple controllers 300 of FIG. 3A) it may be advantageous to obviate provision of the teaching input to one or more entities so as to enable the teacher to focus on the remaining entities.

It will be recognized that while certain aspects of the disclosure are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the invention. This description is in no way meant to be limiting, but rather should be taken as illustrative of the general principles of the invention. The scope of the disclosure should be determined with reference to the claims.

What is claimed:

1. A non-transitory computer readable medium having instructions embodied thereon, the instructions being executable by a processor to perform a method for controlling a robotic platform, the method comprising:
providing a first activation signal, a second activation signal, a first motor control signal, and a second motor control signal, the first activation signal being associated with the first motor control signal and the second activation signal being associated with the second motor control signal;
selecting the first motor control signal for execution, the selection based on a comparison of the first activation signal and the second activation signal; and
instructing the robotic platform to perform a first action based on execution of the first motor control signal.

2. A robotic controller apparatus, the apparatus comprising:
one or more processors configured to execute computer program modules to cause one or more processors to:
provide a first control signal and a second control signal, the first control signal being configured to operate first controllable element of a robotic platform and the second control signal being configured to operate a second controllable element of the robotic platform;
provide a first activation signal and a second activation signal, the first control signal and the second control signal each being configured to enable actuation of the first and second controllable elements, respectively;
determine an enable signal based on competitive information associated with the first control signal and the second control signal; and
enable execution of one and only one of the first control signal or the second control signal based on the enable signal.

3. The apparatus of claim 2, wherein:
the first control signal and the second control signal are provided based on sensory input into the controller apparatus, the sensory input conveying information associated with one or both of the robotic platform or the surroundings; and
the execution of the first control signal or the second control signal by the controllable element is configured to enable the platform to accomplish a first task or a second task, execution of the second task being incompatible with execution of the first task.

4. The apparatus of claim 2, wherein the computer program are further executable to cause one or more processors to cause the first control signal to be provided to a first relay neuron and the second control signal to be provided to a second relay neuron, the first relay neuron being configured to prevent execution by the controllable element of the first control signal absent the enable signal and the second relay neuron being configured to prevent execution by the controllable element of the second control signal absent the enable signal.

5. The apparatus of claim 4, wherein:
the prevention of the execution is based on a first inhibitory signal and a second inhibitory signal being provided to the first relay neuron and the second relay neuron, respectively; and
the execution of the first control signal or the second control signal by the controllable element is configured based on an interruption of one of the first or the second inhibitory signals, the interruption based on the enable signal.

6. The apparatus of claim 5, wherein:
the sensory input comprises a video signal conveying a representation of one or both of a target or an obstacle;
the first task comprises a target approach maneuver; and
the second task comprises an obstacle avoidance maneuver.

7. The apparatus of claim 5, wherein:
the first control signal and the first activation signals are provided by a first task controller operable in accordance with the sensory input to execute the first task;
the second control signal and the second activation signals are provided by a second task controller operable in accordance with the sensory input to execute the second task; and
the interruption is effectuated by activation of one of a first selection neuron or a second selection neuron, activation of a given one of the first selection neuron or the second selection neuron being effectuated based on the enable signal.

8. The apparatus of claim 7, wherein the activation of a given one of the first selection neuron or the second selection neuron is effectuated based on the enable signal being configured based on evaluation of a parameter of the first activation signal versus the parameter of the second activation signal.

9. The apparatus of claim 8, wherein:
the evaluation comprises comparing an onset of the first activation signal to the onset of the second activation signal; and
the parameter comprises onset time.

10. The apparatus of claim 8, wherein:
the evaluation comprises comparing a magnitude of the first activation signal to a magnitude of the second activation signal; and
the parameter comprises activation signal magnitude.

11. The apparatus of claim 2, wherein:
the competitive information associated with the first control signal and the second control signal includes information based on an operation of a first selection neuron and a second selection neuron operable in accordance with a winner-take-all (WTA) process configured to produce the enable signal according to:
configuring the enable signal to activate the first task based on the WTA process indicating the first activation signal as a winning signal; and
configuring the enable signal to activate the second task based on the WTA process indicating the second activation signal as the winning signal.

12. A method of providing a selected control signal of a plurality of control signals to an actuator, the method comprising:
coupling individual ones of the plurality of control signals to a plurality of relays, individual ones of the plurality of relays being configured, responsive to being activated, to provide a respective control signal to the actuator;
preventing provision of all but one of the of plurality of control signals to the actuator by deactivating all but one of the of plurality of relays;
based on a plurality of activation signals associated with individual ones of the plurality of control signals, determining a relay selection signal configured to activate a relay of the plurality of relays; and
effectuating provision of the selected control signal responsive to activation of the relay of the plurality of relays based on the selection signal.

13. The method of claim 12, wherein individual ones of the plurality of control signal comprise spiking signal.

14. The method of claim 12, wherein:
the selected control signal and the selection signal comprise spiking signals; and
individual ones of the plurality of control signals comprise at least one of a spiking signal or an analog signal.

15. The method of claim 12, wherein individual ones of the plurality of activation signals comprise a binary signal.

16. The method of claim 12, wherein individual ones of the plurality of activation signals comprise digital signal characterized by two or more bits.
